(19) United States
(12) Patent Application Publication
(10) Pub. No.: US 2013/0222194 A1
(43) Pub. Date: Aug. 29, 2013

(54) Fire Hydrant Marker Repeater

(71) Applicant: David A. Albert, Columbia, MD (US)

(72) Inventor: David A. Albert, Columbia, MD (US)

(73) Assignee: AXIOMETRIC, LLC, Columbia, MD (US)

(21) Appl. No.: 13/406,039

(22) Filed: Feb. 27, 2012

(51) Int. Cl. H01Q 1/12; H01Q 1/42

(52) U.S. Cl. 343/720; 343/872

(57) ABSTRACT

A system includes a fire hydrant; a gain antenna operatively connected to the fire hydrant; at least one battery operatively connected to the fire hydrant; and a radio repeater operatively connected to the fire hydrant. The gain antenna includes any of a vertical monopole and a dipole antenna. The battery may include a lithium thionyl battery. The battery powers the radio repeater. The radio repeater includes a microprocessor; a memory component; and a radio transceiver. The system may further include a non-metallic enclosure that houses the radio repeater. The gain antenna may be operatively connected to the radio repeater inside the non-metallic enclosure. The radio repeater may further include an electronic voltage reference source that provides a stable voltage reference level that is lower than a lowest battery operating voltage of the at least one battery.

### BACKGROUND

1. Technical Field

The embodiments herein generally relate to remote monitoring systems, and, more particularly, systems used to electronically monitor utility devices.

2. Description of the Related Art

Water utilities frequently deploy radio-based monitoring and control systems for a variety of purposes such as monitoring water pressures, storage tanks, effluent levels, and water metering/billing. Because the geographic regions served by water utilities are often large, their radio systems frequently require additional equipment to help carry the radio signals over large distances. Unfortunately, water utilities have limited locations where they can deploy such equipment; locations with power are often limited to large installations such as pump/lift stations and large water storage towers.

Water utilities generally have a large number of fire hydrants dispersed across their service region. The utilities typically own the hydrants and an easement around them allowing them to deploy equipment at the hydrant site. Unfortunately, fire hydrants are typically metal and radio frequencies cannot pass through metal easily making placement of a transceiver inside a hydrant unfeasible. Moreover, transceivers attached to the outside of a fire hydrant are subject to theft and abuse and they remain relatively low to the ground where their antennas are limited in range. Ideally, a radio antenna should be placed as high as possible to maximize range.

Conventional solutions generally are aimed towards fire hydrant locating or monitoring systems. However, these systems are simply used to locate a fire hydrant and do not typically allow for receiving information pertaining to the water line servicing that fire hydrant or surrounding areas. For example, U.S. Patent Application Publication No. 2007/0120664, the complete disclosure of which, in its entirety, is herein incorporated by reference provides a system that locates fire hydrants. However, this system places a receiver on the fire hydrant and then transmits a signal from a transmitter to the receiver causing the receiver to generate a flashing light to allow for the visual discovery of the fire hydrant. Such a system is beneficial when attempting to locate a fire hydrant that is hidden by bushes, trees, snow, vehicles, etc. However, while useful for the purpose for which it was intended, this system only passively generates a locating signal. In other words, a transmitter is required for actuating the receiver to generate the flashing light. This system does not actively generate a signal from the fire hydrant without first being provoked. Moreover, this system only provides a flashing light to alert firemen attempting to locate a hidden fire hydrant during an emergency response. However, if the fire hydrant is covered by significant amounts of snow, which often happens as a result of snow drifts and snow plows pushing snow over a fire hydrant, then the flashing light will not be visible. Moreover, such a system does not allow a water utility company to monitor or remotely determine the location of a fire hydrant or water utility line.

Another system is described in U.S. Pat. No. 7,980,317, the complete disclosure of which, in its entirety, is herein incorporated by reference. This system uses a mounted operating nut that provides on/off use data of the fire hydrant, along with a monitor that describes operating conditions and historical data of the fire hydrant. However, this system, while beneficial for its intended purpose, requires a mechanical nut and transmitter sub-system to generate meaningful data of the fire hydrant's use and/or history. Because such a sub-system is exposed on the outside of the fire hydrant, it is prone to tampering, weathering, destruction, and other malfunctions causing operational deficiencies. Moreover, this system uses the movement of the mechanical nut as an indicator to transmit a signal from the transmitter. In other words, the transmitter does not actively and repeatedly generate a signal; rather it must rely on the detected movement of the nut before generating any signal.

Various solutions have been attempted including caps for the pumper hose nozzles which camouflage a small battery, electronics, and antenna. Unfortunately, these solutions are limited due to their small size which offers very limited battery power and requires a very small and low antenna, which reduces signal transmission.

### SUMMARY

In view of the foregoing, an embodiment herein provides a system comprising a fire hydrant; a gain antenna operatively connected to the fire hydrant; at least one battery operatively connected to the fire hydrant; and a radio repeater operatively connected to the fire hydrant. The gain antenna may comprise any of a vertical monopole and a dipole antenna. Examples include a quarter wave vertical monopole, half wave vertical dipole, ⅝ths wave vertical monopole, and helical quarter wave monopole. The at least one battery may comprise a lithium thionyl battery. Preferably, the at least one battery powers the radio repeater. The radio repeater may comprise a microprocessor; a memory component; and a radio transceiver. The system may further comprise a non-metallic enclosure that houses the radio repeater. The gain antenna may be operatively connected to the radio repeater inside the non-metallic enclosure. The radio repeater may further comprise an electronic voltage reference source that provides a stable voltage reference level that is lower than a lowest battery operating voltage of the at least one battery.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system block diagram according to an embodiment herein;

FIG. 2 illustrates a block diagram of a radio repeater according to an embodiment herein; and

FIG. 3 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein.

Accordingly, the examples should not be construed as limiting the scope of the embodiments herein.

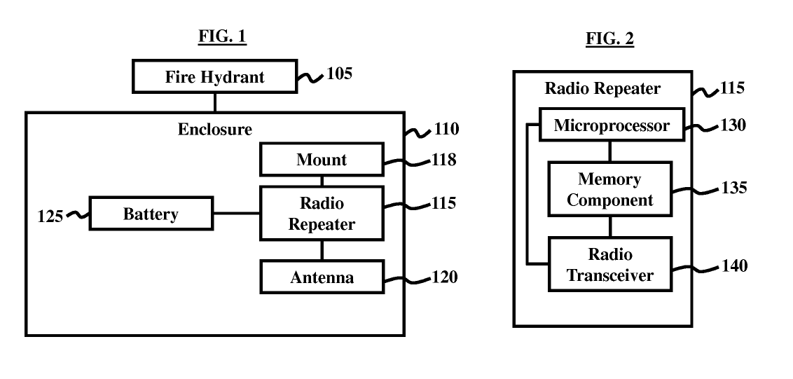

The embodiments herein provide a repeater device used with water utility systems. Referring now to the drawings, and more particularly to FIGS. 1 through 3, where similar reference characters denote corresponding features consistently throughout the figures, there are shown preferred embodiments.

The embodiments herein provide substantial improvement over existing repeater devices by integrating a gain antenna, one or more batteries, and the repeater electronics into a fiberglass or plastic hydrant marker. Water utilities frequently mount a rugged fiberglass marker to the top (bonnet) or pumper nozzle of fire hydrants to make the hydrant locations visible to fire trucks and snow plows when snow has covered the hydrants themselves.

Because the markers are made of materials that are rugged and weatherproof, they offer excellent protection for electronics; whereby the materials are typically also transparent to radio waves allowing a high-performance antenna to be enclosed and hidden within the marker. Because the markers are intended to be elevated, they provide both the length required to contain a high-performance (gain) antenna and the elevation that will allow it to perform well. The typical diameter of hydrant markers is sufficient to contain C-size or D-size lithium-thionyl batteries which are capable of operating the repeater electronics for long periods over the extended outdoor temperatures that fire hydrants are subject to.

As indicated in FIGS. 1 and 2, the embodiments herein include a hollow weatherproof (e.g., fiberglass or plastic, or non-metallic, etc.) enclosure 110 suitably colored and therefore camouflaged as a hydrant marker (typically white with an orange tip) comprising one or more lithium thionyl or type similar batteries 125, which may or may not be encased in the enclosure 110; a vertical monopole or dipole antenna 120 with a gain greater than or equal to 0 dBi; and radio repeater electronics 115 comprising of at least a microprocessor 130, a memory component 135, and a radio transceiver 140. Examples of the antenna 120 may include a quarter wave vertical monopole, half wave vertical dipole, ⅝ths wave vertical monopole, and helical quarter wave monopole.

The radio repeater electronics 115 may operate using standards-based wireless protocols including 802.11 or 802.15 protocols or proprietary protocols such as the MeshPlus® synchronous networking protocols as further described in U.S. Pat. Nos. 7,782,804 and 7,996,534 and U.S. Patent Application Publications 2006/0239333, 2010/0202436, and 2011/0044276, and the radio repeater electronics 115 may include components described in U.S. Pat. Nos. 7,430,397, 7,869,761, and 8,019,278, whereby the complete disclosures of all of these, in their entireties, are herein incorporated by reference. These protocols allow extended battery operation of the radio repeater electronics 115.

The radio repeater electronics 115 are mounted in the fiberglass enclosure 110 using a mount 118 that protects the electronics 115 from shock and water intrusion such as a waterproof shock-absorbing potting compound. The antenna 120 is operatively connected to the repeater electronics inside the fiberglass enclosure 105 either by direct connection or using waterproof connectors and coaxial cable. The batteries 125 are operatively connected to the electronics either directly or using a waterproof connector that allows them to be replaced in the field. FIG. 1 shows the battery 125 located inside the enclosure 110. In another embodiment, the battery 125 is located outside the enclosure 110 and connected to the enclosure 110 via a waterproof connector (not shown). The repeater electronics 115 include an electronic voltage reference providing a stable voltage reference lower than the lowest battery operating voltage allowing the repeater electronics to monitor the battery voltage and report a low battery condition.

The radio repeater electronics 115 include operating software that receives, stores, and forwards radio messages to a remotely located monitoring station or some other data collection and/or storage system. For example, a corresponding remotely located transceiver (not shown) may be used to receive the radio signals from the repeater electronics 115. The batteries are capable of operating the radio repeater electronics 115 for periods exceeding one year. Accordingly, the embodiments herein can both hardware and software elements. The embodiments that are implemented in software include but are not limited to, firmware, resident software, microcode, etc. The operating software may be embodied as a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system is used for storing and/or executing the program code and may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/0 controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

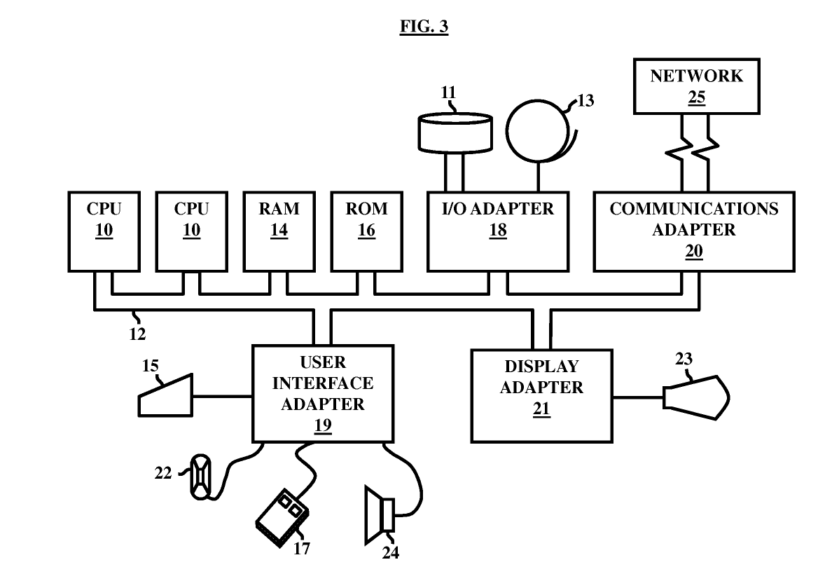

A representative hardware environment for practicing the embodiments herein is depicted in FIG. 3. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system comprising:
a fire hydrant;
a gain antenna operatively connected to said fire hydrant;
at least one battery operatively connected to said fire hydrant; and
a radio repeater operatively connected to said fire hydrant.

2. The system of claim 1, wherein said gain antenna comprises any of a vertical monopole and a dipole antenna.

3. The system of claim 1, wherein said at least one battery comprises a lithium thionyl battery.

4. The system of claim 1, wherein said at least one battery powers said radio repeater.

5. The system of claim 1, wherein said radio repeater comprises:
a microprocessor;
a memory component; and
a radio transceiver.

6. The system of claim 1, further comprising a non-metallic enclosure that houses said radio repeater.

7. The system of claim 6, wherein said gain antenna is operatively connected to said radio repeater inside said non-metallic enclosure.

8. The system of claim 5, wherein said radio repeater further comprises an electronic voltage reference source that provides a stable voltage reference level that is lower than a lowest battery operating voltage of said at least one battery.

9. A radio repeater device mounted adjacent to a fire hydrant, said radio repeater device comprising:
a gain antenna;
an electronics component operatively connected to said gain antenna; and
at least one battery operatively connected to said electronics component.

10. The device of claim 9, wherein said gain antenna comprises any of a vertical monopole and a dipole antenna.

11. The device of claim 9, wherein said at least one battery comprises a lithium thionyl battery.

12. The device of claim 9, wherein said at least one battery powers said radio repeater.

13. The device of claim 9, wherein said electronics component comprises:
a microprocessor;
a memory component; and
a radio transceiver.

14. The device of claim 9, further comprising a non-metallic enclosure that houses said electronics component.

15. The device of claim 14, wherein said gain antenna is operatively connected to said electronics component inside said non-metallic enclosure.

16. The device of claim 13, wherein said electronics component further comprises an electronic voltage reference source that provides a stable voltage reference level that is lower than a lowest battery operating voltage of said at least one battery.

17. A non-metallic enclosure comprising:
at least one battery;
a radio repeater operatively connected to said at least one battery; and
a gain antenna operatively connected to said radio repeater.

18. The enclosure of claim 17, wherein said gain antenna comprises any of a vertical monopole and a dipole antenna.

19. The enclosure of claim 17, wherein said at least one battery comprises a lithium thionyl battery, and wherein said at least one battery powers said radio repeater.

20. The enclosure of claim 17, wherein said radio repeater comprises:
a microprocessor;
a memory component;
a radio transceiver; and
an electronic voltage reference source that provides a stable voltage reference level that is lower than a lowest battery operating voltage of said at least one battery.
